(19) United States
(12) Patent Application Publication
(10) Pub. No.: US 2017/0220773 A1
(43) Pub. Date: Aug. 3, 2017

(54) SYSTEM AND METHOD FOR CONTEXTUALIZED TRACKING OF THE PROGRESS OF A CLINICAL STUDY

(71) Applicant: Medidata Solutions, Inc., New York, NY (US)

(72) Inventors: Angel Janevski, New York, NY (US); Mladen Laudanovic, New York, NY (US)

(21) Appl. No.: 15/014,849

(22) Filed: Feb. 3, 2016

(51) Int. Cl. G06F 19/00; G06Q 50/22; G06Q 10/06

(52) U.S. Cl. CPC G06F 19/363; G06Q 10/067; G06Q 50/22

(57) ABSTRACT

An improved system for tracking the progress of a clinical study includes a classifier generator, a classifier application subsystem, a study stage annotation subsystem, a progress status models generator, an aggregation module, and a progress status evaluation subsystem. The classifier generator automatically generates clinical data element classifiers by evaluating clinical data containers and clinical study stage attributes across clinical studies; the classifier application subsystem applies the clinical data element classifiers to classify clinical data elements into pre-determined categories; the study stage annotation subsystem uses the clinical data element classifiers and the classified clinical data elements to determine clinical study stages; the progress status models generator generates at least one progress status model based on the clinical study stages, the aggregation module selects and aggregates the classified clinical data elements and clinical study stages; and the progress status evaluation subsystem computes the state of at least one progress status model. The progress status evaluation subsystem generates at least one progress status of the clinical study by using the clinical data element classifiers and clinical data to compare contextualized study properties of one or more associated clinical study stages. An improved method for tracking the progress of a clinical study is also described and claimed.

### BACKGROUND

Clinical studies are generally very expensive to undertake and may often take a long time to complete. During the course of a clinical study, many steps may be taken to ensure optimal execution of the study and maintain high quality of the data collected. These steps may be applied to various aspects of the study data, study participants, and study execution at the level of study sites, which constitute the main operating units in a clinical study. One component of site (and study) monitoring is to monitor the progress of a clinical study.

Up to now, progress of a clinical study has generally been measured very coarsely, either based on the progress of the whole study or possibly based on the progress of each site. For example, FIG. 1 is a conventional schematic diagram showing clinical trial study and site progress. The example study comprises three sites, each of which appears to be progressing at about the same pace, and the study itself seems to be progressing at a similar pace. But such a view often does not provide enough information as to what is happening at each site and where problems may be occurring within each site.

### BRIEF DESCRIPTION OF THE DRAWINGS

FIG. 1 is a conventional schematic diagram of clinical trial study and site progress;

FIGS. 2A-2C are schematic diagrams showing exemplary stages of a clinical study, according to embodiments of the present invention;

FIG. 3 is a graph comparing data breadth or study design element coverage along the x-axis and attributes or semantic information along the y-axis, according to embodiments of the present invention;

FIGS. 4A-4D illustrate visualizations of clinical study data under clinical study stages based on aggregated system generated progress curves, according to an embodiment of the present invention;

FIGS. 5A-5D illustrate visualizations of clinical study data under data elements based on aggregated system generated progress curves, according to an embodiment of the present invention;

FIG. 6A is a block diagram of an improved system for tracking progress of a clinical study, according to an embodiment of the present invention;

FIGS. 6B and 6C comprise a more detailed block diagram of FIG. 6A, according to an embodiment of the present invention;

FIG. 7A is a block diagram of a part of the system of FIGS. 6B and 6C for classifying clinical study stage attributes and clinical data containers, according to an embodiment of the present invention;

FIG. 7B is a flowchart for inducing a classifier that provides classification for clinical study design elements, according to an embodiment of the present invention;

FIG. 8 is a schematic diagram and flowchart for building learning datasets for Data Container Classifier Induction, according to an embodiment of the present invention.

FIG. 9 is a flowchart of a method for tracking the progress of a clinical study by generating an industry standard, according to an embodiment of the present invention; and

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Poor performance in the progress of a clinical study may be indicated by large delays or completion differences at one site compared to another, or by not meeting expected study targets. By being able to identify progress trends on a site basis, a clinical study basis, or other parametrical basis, site monitors may be able to identify poor-performing sites or slow sites, and concentrate on monitoring on those sites, with the possible goal of finishing the clinical study more quickly and therefore saving money for the sponsor or contract research organization (“CRO”). Such monitoring may include calling the site and asking why there are deviations or sending people to the site to verify the data or the collection process.

Embodiments of the present invention may be used to track the progress of clinical studies, but the invention is not limited to such embodiments. As alluded to above, a coarse study or site view may not provide enough information regarding the study's progress or the performance of each site. For example, site and study monitoring may not provide a comprehensive view of how data are collected and managed. In tracking the progress of a clinical study, one may examine a variety of data elements—a data point, a data record, or a data page. In a clinical study that records information using, for example, case report forms (“CRFs”), whether manual or electronic (“eCRF”), a data point (or “datapoint”) may be a field on such a form, a data record may be a group of fields on the form, and a data page (or “datapage”) may be the form itself. The fields may include a subject's demographic data (e.g., name, address, age, gender, birthdate) and may also include clinical data for a visit, e.g., blood pressure, temperature, heart rate, and pain assessment. A record may be a composite data element—a collection of several fields in a form. A datapage may also imply a composite data element in which history and statuses of individual (“lower”) data elements may be combined into a bigger picture. Any of these types of data elements may be monitored to understand the progress of the clinical study. One may track a clinical study by examining the chronology of various aspects related to these forms.

Traditional data tracking tools may use only the current status of these data elements (sometimes called “object status”) and may not include input from historical changes in the data collection process. Such progress tracking is additionally difficult to assess as it does not provide fine-grain monitoring that contextualizes the monitoring data. Rather than indicating that a site is not performing well, it would be beneficial to contextualize such monitoring data to indicate more specifically in which ways the site is not performing well.

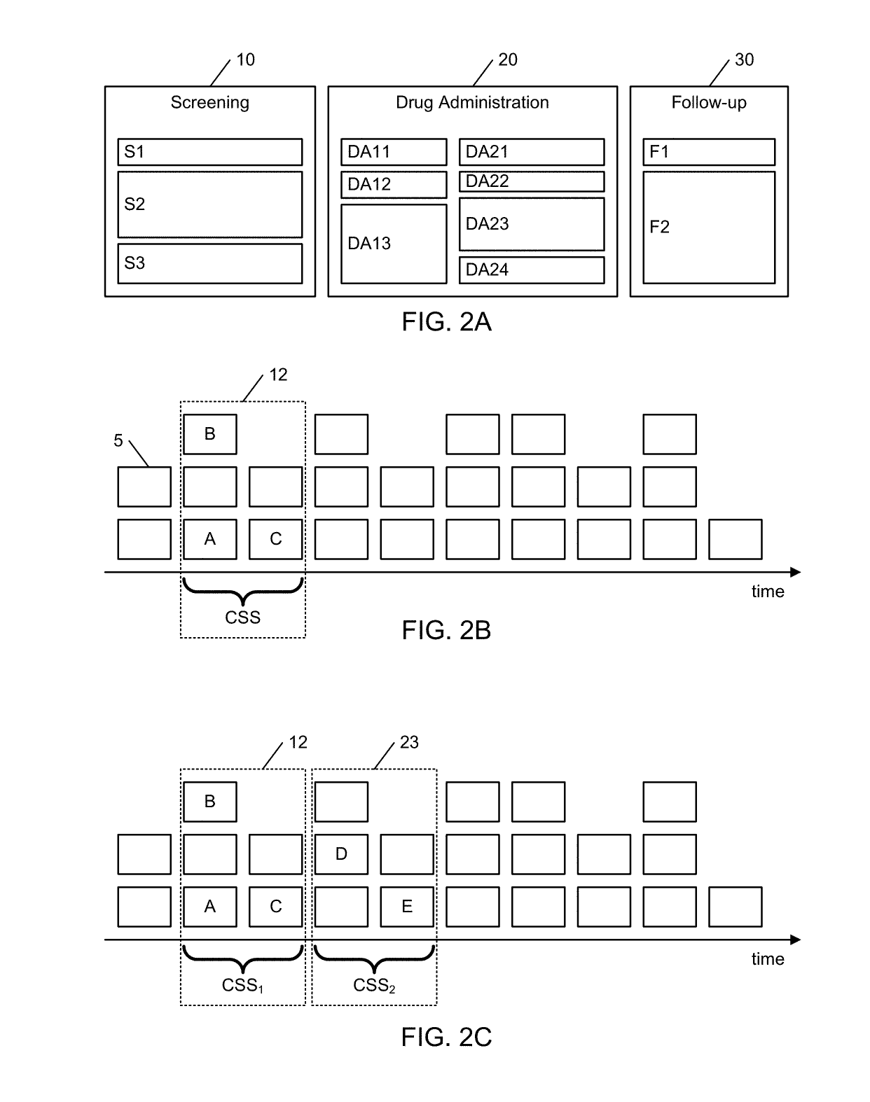

To that end, the inventors have developed a context-sensitive system for tracking progress of a study, in this case, a clinical study, whereby the study is divided into stages, and the progress of each stage may be monitored to determine where progress may be stalled. FIG. 2A is a schematic diagram showing exemplary stages of a clinical study, according to an embodiment of the present invention. The stages may capture logical parts of a study that are relevant clinically and in study management. In this example, a clinical study may include three stages, Screening 10, Drug Administration 20, and Follow-up 30. There may also be sub-stages, as shown by the two drug administration sub-stages in FIG. 2A. Each of the stages/sub-stages may include study design elements, which may be internally grouped for order, e.g., S1, S2, and S3 in Screening; DA11, DA12, DA13, DA21, DA22, DA23, and DA24 in Drug Administration; and F1 and F2 in Follow-up. In clinical studies, related forms are often grouped in meaningful sets referred to as Folders, which often may map to a sub-stage as described in the invention.

The study design elements in the Screening stage may include surveying demographics (S1) (such as by an intake or enrollment questionnaire), measuring vital signs (S2), and generating clinical laboratory data (S3) in order to screen against clinical study requirements and establish a baseline. Study design elements in the Drug Administration stage may include performing a physical exam (DA11, DA21, since there may be an exam in each drug administration sub-stage), measuring vital signs (DA12, DA22), dispensing the drug being studied (DA13, DA23), and possibly generating clinical laboratory data again (DA24). Study design elements in the Follow-up stage may include performing a physical exam (F1) and generating clinical laboratory data again (F2).

Three stages are shown in FIG. 2A, but additional study design elements exist that may not be unique to a stage or a sub-stage, for example, design elements that capture Adverse Events or Unscheduled Visits. Typically, studies have similar structures at some level, and at a lower level there may be specific differences. For example, in oncology, Drug Administration may have several sub-stages (or cycles), which may not be typical in other therapeutic areas.

FIGS. 2B-2C generalize FIG. 2A even more. FIG. 2B is a schematic diagram showing study design elements 5 that make up stages of a clinical study, according to embodiments of the present invention. FIG. 2B illustrates the concept of a Custom Study Stage or CSS. The study design elements may be those shown in FIG. 2A, e.g., S1-S3, DA11-DA24, F1-F2. A custom study stage 12 may be made up of a number of study design elements, which may include data elements such as A, B, and C. Being able to selectively discover data elements enables the setting of content (e.g., only forms A, B, and C), the start of the stage (e.g., creation of elements A and B), and end of the stage (e.g., completion of element C). These data elements define the content and information flow in the study design elements that are being tracked and/or classified. Data may thus be classified at the beginning and the end of a clinical study stage, and the system may use this classification to provide progress tracking with a specific meaning attached to the clinical study stage. A custom study stage is variable—it may be an entire study or an entire study with a subset of data elements. There may also be combinations of custom study stages as a composite CSS, as shown in FIG. 2C. CSS₁ 12 and CSS₂ 23 can be viewed as a single CSS but having the ability to also provide individual metrics or model each one separately. Mid-points for the data may be created at the points where individual CSSs begin and end. A clinical study stage is generally considered a meaningful subset of the clinical trial information. In this specification, a custom study stage is defined specifically based on its data containers, but the discussion may use “custom study stage,” “clinical study stage,” and “study sub-stage” interchangeably.

The underlying relations and properties of clinical study design elements as shown in FIG. 3 are what allow this invention to enable contextualized study progress tracking. This graph compares study design element coverage along the x-axis in increasing breadth of data, and examples of attributes or semantic information along the y-axis in increasing level of semantics. (An attribute is any kind of annotation either provided in advance or derived by classification methods described later.) The bottom row of study design elements includes Field, Form, Folder, and Study, in order of increasing study data breadth. The next row provides examples with more semantic specificity for the study design elements such as Lab, Vitals, Screening, and TA (therapeutic area), respectively. The third row provides even more semantic specificity, such as a Tumor subtype Field, a Drug Administration Form, and clinical study Phase for a Study.

For a given clinical (or custom) study stage, the system may provide progress status information and derive unique characterizations including metrics and predictions. Using this view of a clinical study, the fact that data entry has stalled in the drug administration stage may indicate delays in entering the data, whereas a lack of data in the screening (or enrollment) stage may indicate low enrollment rates in the study or the site. Such contextualized or finer-grain monitoring may provide both operational and clinical insights into the categorical domain of the data being collected, which may relate to adverse events (AEs), lab, drug administration, randomization, follow-up, and other stages, which may be reflected in the types of forms generated. For example, tracking AE-type forms may provide insights into the occurrence of AEs in the study. Similarly, tracking lab, drug administration, randomization, follow-up, and other types of forms may also be insightful.

A context-sensitive system for progress tracking may establish and represent study status in unique detail by using additional information about the data elements in the study. Specifically, the system may combine monitoring data based on progress curves for individuals or groups of data elements within parts of a study to implement metrics and tools that provide insight into the progress of the study. These progress curves may be generated as described in U.S. patent application Ser. No. 14/492,597, assigned to the same assignee and incorporated by reference herein in its entirety.

The system monitors how different stages of a study contribute to the progress of the study at a particular point in time. But sometimes data element classification and stages are not readily available, in which case the system may use a classification module to automatically generate classifiers that classify data elements by evaluating clinical data elements and thus enable annotation of clinical study stages with attributes in any clinical study. With annotated/classified data elements and characterized clinical study stages, the system may use an aggregation module to aggregate datapoints and other data elements in a clinical study, enabling comparison of contextualized study properties between subjects and/or sites within a study and/or between different studies. This specification will describe the stages in more detail, and then discuss the classification and aggregation.

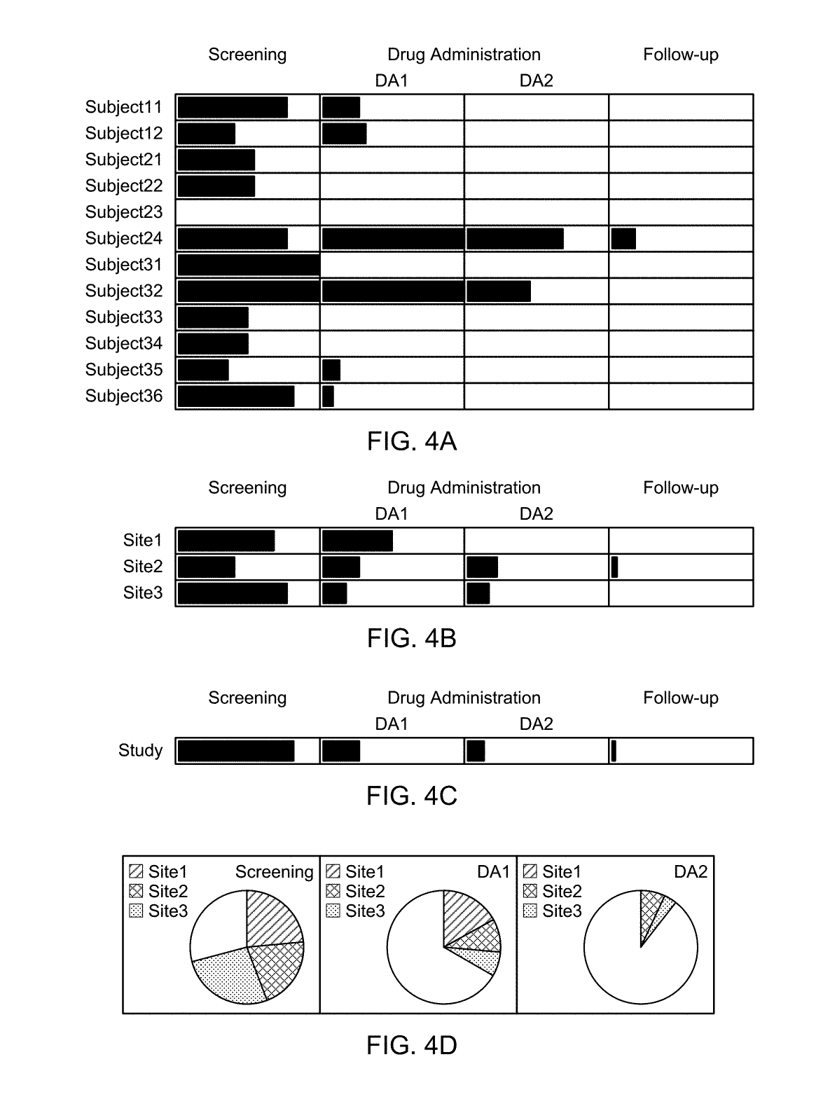

FIGS. 4A-4D illustrate visualizations of clinical study data under study stages based on aggregated, system-generated progress curves. The system may aggregate progress curves based on clinical data elements to enable progress monitoring per site and study stages or for the study overall. The system may also aggregate the annotation of clinical data elements with the data statuses. As each subject's data are characterized for each clinical study stage, the status/progress information of subjects at each site may be aggregated around the exact same study stage.

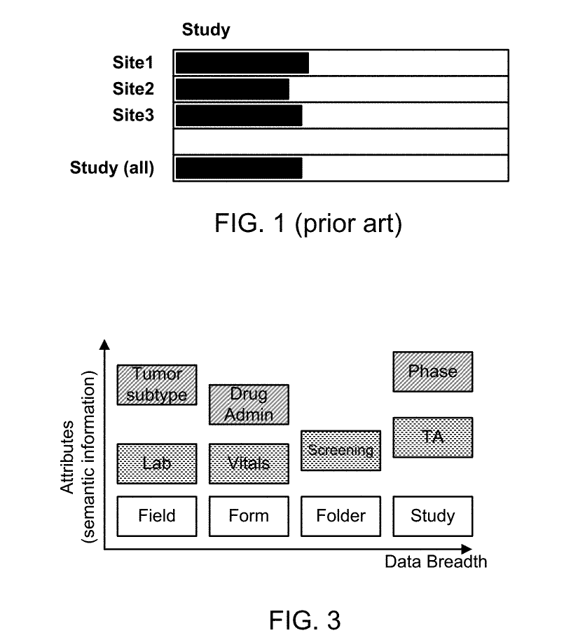

Progress tracking that does not evaluate clinical study stage attributes and clinical data elements generally does not provide fine-grain monitoring that contextualizes the monitoring data. Such progress tracking is shown in FIG. 1, in which all sites in that example appear to be at a comparable state in terms of progress. However, as illustrated in FIGS. 4A-4D, when evaluating clinical study stage attributes and clinical data elements, these sites have different dynamics, as described below.

The example of a clinical study having three clinical study stages, screening, drug administration, and follow-up, some of which may have sub-stages such as DA1 and DA2 in drug administration, is shown in a slightly different configuration in FIG. 4A. Each row represents a patient, Subject [I][J], where I is the site, and J is the patient number for that site. The system may aggregate data for each patient under the study stage or sub-stage. Each cell in the table may represent the fraction of the data that corresponds to a particular state (acquired, verified, locked, etc., as described in U.S. application Ser. No. 14/492,597). These aggregated data representations indicate that each patient has different dynamics.

The system may aggregate the annotation of the study stages/sub-stages and data statuses to generate data representations in FIG. 4B that monitor progress per site and per study stage/sub-stage, or the data representations in FIG. 4C that monitor progress for the study overall per stage/sub-stage.

The data may be summarized in other ways. The bars in FIGS. 4A-4C may be further enhanced with error-bars and other statistical indicators that allow a user to quickly assess study status and potentially determine which site requires user action, if any. FIG. 4D shows pie charts that demonstrate the relative contribution of each site in each stage/sub-stage of the clinical study, and also demonstrate the progress status of each stage/sub-stage in the study as a whole.

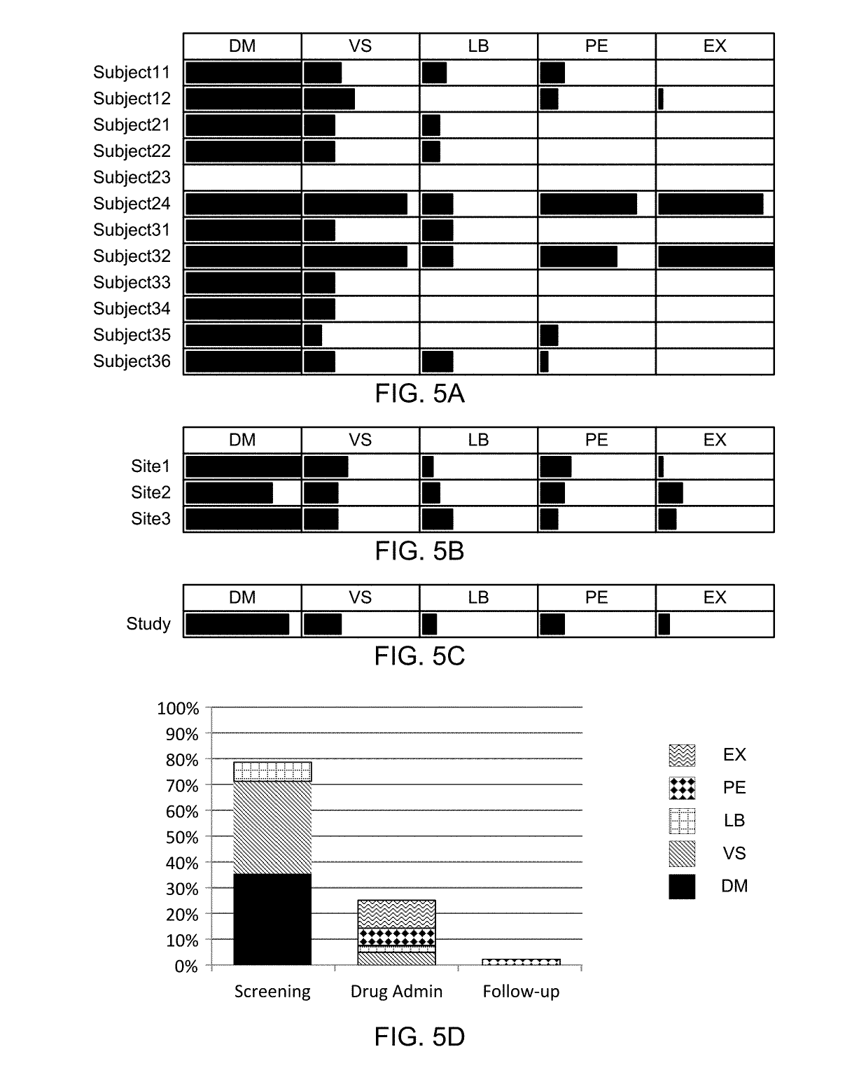

FIGS. 5A-5D illustrate visualizations of clinical study data under data elements based on aggregated, system-generated progress curves. The system may calculate and present the progress of a study by properties of study design elements other than sites, which may include clinical data elements such as demographics (DM), vital signs (VS), clinical laboratory (LB), physical exam (PE), and drug exposure (EX). Referring back to the study design/study design elements shown in FIG. 2A, the system may apply the following annotations of clinical data elements to the study design elements:

| | Study Design Element |
|---|---|
| Study Design Element | Annotation |
| S1 | DM |
| S2 | VS |
| S3 | LB |
| DA11 | PE |
| DA12 | VS |
| DA13 | EX |
| DA21 | PE |
| DA22 | VS |
| DA23 | EX |
| DA24 | LB |
| F1 | PE |
| F2 | LB |

Using these system-generated annotations, the system may calculate and present the progress of a study for each subject, as shown in FIG. 5A, or per site, as shown in FIG. 5B, or for an entire study, as shown in FIG. 5C. The system may also automatically combine and present aggregated study stage and clinical data elements, as shown in FIG. 5D, which may be used to compare sites within a particular study, to build indicators of sites that exhibit unusual patterns with respect to the sites. The studies may be compared to generate progress dynamics within a particular study stage across similar studies.

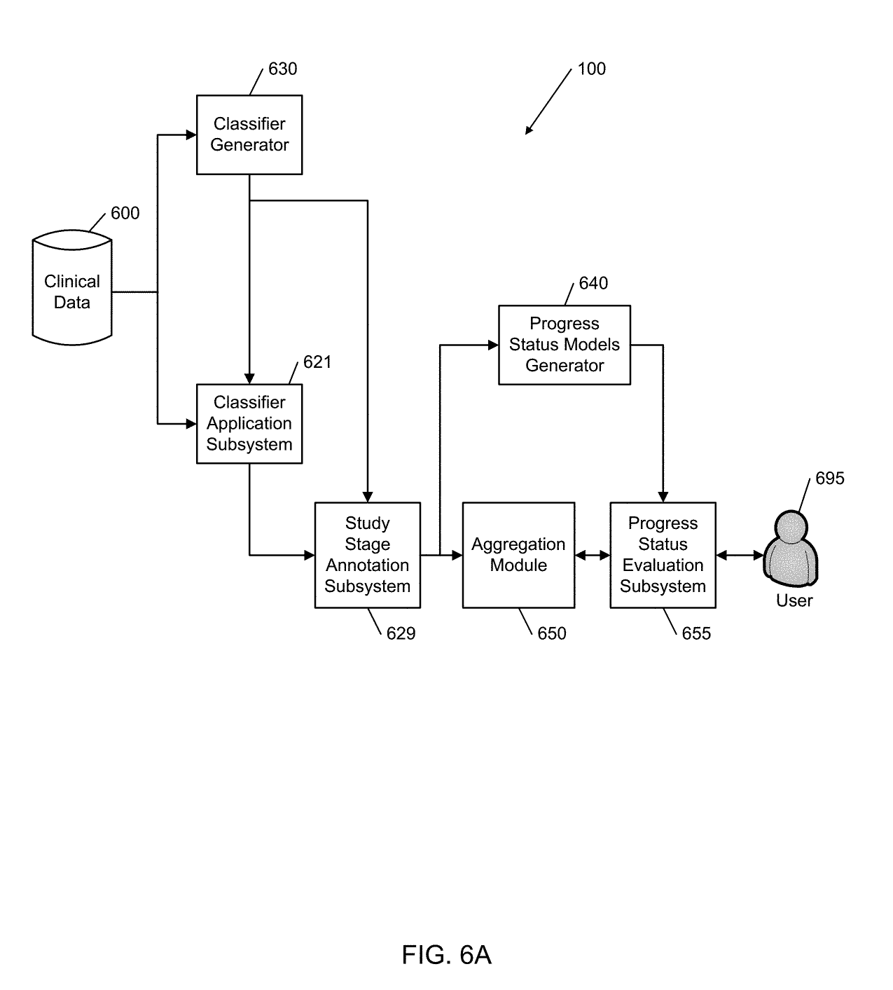

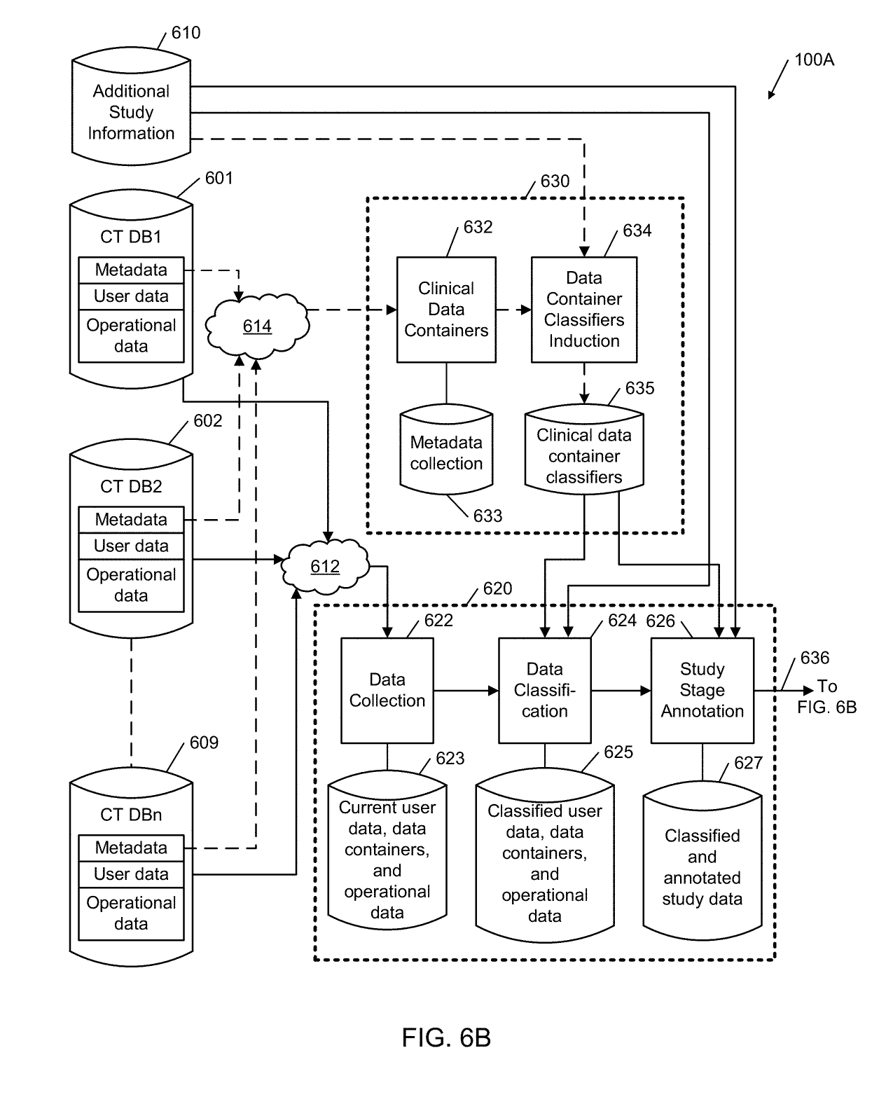

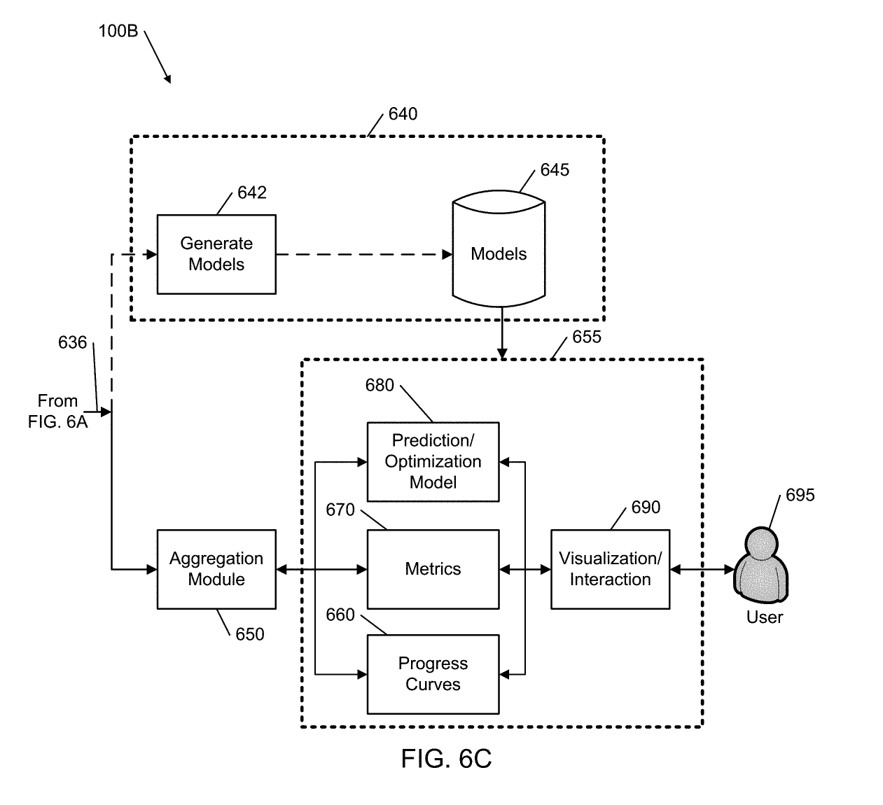

FIG. 6A is a block diagram of an improved system 100 for tracking progress of a clinical study, according to an embodiment of the present invention. System 100 includes classifier generator 630, classifier application subsystem 621, study stage annotation subsystem 629, progress status models generator 640, aggregation module 650, and progress status evaluation subsystem 655. Clinical data 600, which may include any type of information used in or derived from a clinical study, such as patient demographic information, patient medical information, other medical information, drug information, site information, information about principal investigators and other clinical study management personnel, adverse event information, etc., may be input to classifier application subsystem 621, and metadata may be input to classifier generator 630. Classifier generator 630 may generate clinical data element classifiers by evaluating clinical data containers and clinical study stage attributes across clinical studies. Classifier application subsystem 621 may apply the clinical data element classifiers to classify clinical data elements into pre-determined categories. Study stage annotation subsystem 629 uses the clinical data element classifiers as well as the classified clinical data elements from classifier application subsystem 621 to determine clinical study stages. Thus, in FIGS. 2B and 2C, classifier application subsystem 621 annotates the A, B, C, D, and E elements, and then study stage annotation subsystem 629 calls the CSS, CSS₁, and CSS₂. Progress status models generator 640 generates at least one progress status model based on the clinical study stages. Aggregation module 650 selects and aggregates the clinical study stages from study stage annotation subsystem 629 and the classified clinical data elements from classifier application subsystem 621 via study stage annotation subsystem 629. Progress status evaluation subsystem 655 computes the state of at least one progress status model. Progress status evaluation subsystem 655 implements multiple modules that jointly enable study progress tracking by using classified data elements and normalized datapoints to characterize a progress status of an associated study stage via some metrics, or a predictive model that enables acting on or optimization of some study aspects. Progress status may include metrics such as time from start to completion for one subject; percent data collected; and percent data verified. Predictive models may enable estimation of predicted time to completion for one or a group of or all subjects; rate of new subjects entering a study stage; and rate of subjects leaving a study stage. Aggregation module 650 and progress status evaluation subsystem 655 generate at least one progress status of the clinical study by using the clinical data element classifiers and clinical data to compare contextualized study properties of one or more associated clinical study stages. Aggregation module 650 may also be informed as to how to aggregate data based on the model evaluated in progress status evaluation subsystem 655 and the user's input. For example, progress curves 660 (shown in FIG. 6C) may by default present data aggregated at study level, but based on user input, the aggregation may be performed at site level.

FIGS. 6B and 6C are two parts of a more detailed block diagram of FIG. 6A-FIG. 6B shows part 100A and FIG. 6C shows part 100B. Clinical data 600 may comprise clinical study (or clinical trial) databases DB1 to DBn (601-609). Non-limiting examples of such a database include Medidata Rave®, an electronic data capture (EDC) and clinical data management (CDMS) platform, Medidata Balance®, a randomization and trial supply management program, clinical trial management systems (CTMS), electronic patient reported outcomes (ePRO) databases, and databases that may store real-time data from devices attached to clinical study subjects. These data fall into at least three categories—metadata, user data, and operational data—which are treated somewhat differently by system 100. Additional study information 610 may be available to describe properties of the study, which may not be in the Clinical Study Databases, for example, Therapeutic Area, and Phase of a study. Metadata (indicated by the dashed lines in FIGS. 6B and 6C) from clinical study databases 601-609 may be transmitted to classifier generator 630 via a network 614; metadata, user data, and operational data (collectively indicated by solid lines) from clinical study databases 601-609 may be transmitted to block 620 via a network 612. Networks 612, 614 may be the Internet, an intranet, or another public or private network. Access to networks 612, 614 may be wireless or wired, or a combination, and may be short-range or longer range, via satellite, telephone network, cellular network, Wi-Fi, over other public or private networks, via Ethernet, or over local, wide, or metropolitan area networks (i.e., LANs, WANs, or MANs).

Blocks 620, 630 may reside on one computer, having a processor and memory, or on a series of computers, processors, and memory that may themselves be connected via a local or wide-area network. Block 620 may comprise classifier application subsystem 621 and study stage annotation subsystem 629 in FIG. 6A. Classifier application subsystem 621 may include data collection module 622 and data classification module 624, along with associated databases—current data database 623 and classified data database 625, respectively; study stage annotation subsystem 629 may include study stage annotation module 626 and classified and annotated study database 627. Data collection module 622 collects data from one or more of the CT databases 601-609. This may include digestion, cleaning, and aggregation of some or all of the data in the databases. This module may extract, determine, or calculate current user data, current data containers, and current operational data and store that information in current data database 623. Data containers are generic data structures that are either data fields defined to store specific type of data or combinations of clinical data containers. Based on this recursive definition of data containers, by defining data fields and through various combinations of data fields and data containers, a complete clinical trial design can be implemented, as will be described below. Data container classifiers induction module 634 may automatically generate a classifier that classifies data elements by evaluating them and associated study stages across clinical studies. The generated classifier may be stored in clinical data container classifiers database 635. Data classification module 624 may apply these classifiers to characterize the data in current data database 623, and study stage annotation module 626 may then use the classifiers to annotate clinical (and custom) study stages, as described above with respect to FIGS. 2A-2C. Information from study stage annotation module 626 may then be used to generate progress status models as described later.

When data elements classification and stages are not readily available, the system provides a set of modules in classifier generator 630 that, based on study metadata in clinical trial databases dB1 . . . dBn, induce data container classifiers that are applied in the analysis pipeline in block 620.

The clinical study design elements used by this system may be defined through clinical data containers, which were described above as generic data structures that allow various combinations of clinical data containers to form other clinical data containers and ultimately complete a clinical study. (Note that in this specification, we use study design elements and data containers interchangeably.) As an example, a clinical study may be defined by a collection of clinical data containers of type Folder, each of which contains multiple clinical data containers of type Form, each of which contains multiple clinical data containers of type Field. Some clinical study design elements may include demographics, vital signs, clinical laboratory, physical exam, drug exposure, etc.

In one embodiment, a minimal set of properties for these containers may include: <identifiers, content_properties, rendering_properties, parent, children>. “Identifiers” may represent one or more ways to refer to an instance of the container, such as name, sex, birthdate, place of birth. “Content_properties” may represent constraints (e.g., format, allowed range of values, default value) or enrichment (e.g., data dictionary) of the content in the clinical data container instance. “Rendering_properties” may represent behavior when a clinical data container instance (i.e., a data element) is displayed. “Children” may represent other clinical data containers that are part of this clinical data container.

For example, a form called “DEMOGRAPHICS” may have the following properties:

| Identifiers | Content_properties | Rendering_properties | Children |
|---|---|---|---|
| DEMO- | <type:form> | | NAME, SEX, |
| GRAPH- | | | BIRTHDATE, |
| ICS | | | ZIP |

The form has the following fields (i.e., children):

| Iden- | | | |
|---|---|---|---|
| tifiers | Content_properties | Rendering_properties | Children |
| NAME | <type:field> <edit:string> | <order:1> | — |
| SEX | <type:field> <edit:choice> | <order:2> | — |
| | <dictionary:DD_SEX> | | |
| BIRTH- | <type:field> <edit:date> | <order:3> | — |
| DATE | | | |
| ZIP | <type:field> <edit:string> | <order:4> | — |

where “type” is the type of clinical data container (e.g., folder, form, field), “edit” is the type of entry (e.g., “string” for an alphanumeric string, “choice” for a defined selection, “date”), “dictionary” is a reference to a pre-defined list of terms acceptable as data entries for the field, and “order” shows the order of fields in the form.

The system may normalize clinical data elements across different clinical studies for meaningful comparison and interpretation of the data from the different studies. Clinical data elements may be manually pre-annotated at creation time with standardized terms and categories or curated later. Examples of pre-annotations are therapeutic area for study, visit type for folder (e.g., screening, baseline, administration, follow-up), form type for form (e.g., SD™ domain such as vital signs, demographics), and standardized terms for field (e.g., subject sex, date of birth, medication name). (“SD™” stands for Study Data Tabulation Model, see www.cdisc.org/sdtm.) A set of tags may be assigned to all clinical data elements, and a tag may be a classifier that allows consolidating multiple clinical data elements.

For example, the system may reconcile the following two fields, “sex” and “gender,” by assigning the tag <tag:FIELD_TAG_DM_SEX>:

| Iden- | | | Chil- |
|---|---|---|---|
| tifiers | Content_properties | Rendering_properties | dren |
| SEX | <type:field> | <order:2> | |
| | <edit:choice> | | |
| | <dictionary:DD_SEX> | | |
| | <tag:FIELD_TAG_DM_SEX> | | |

| Iden- | | | Chil- |
|---|---|---|---|
| tifiers | Content_properties | Rendering_properties | dren |
| GEN- | <type:field> | <order:3> | |
| DER | <edit:text> | | |
| | <tag:FIELD_TAG_DM_SEX> | | |

Additionally, the system may reconcile the following two forms by assigning the tag <tag:FORM_TAG_DM>:

| Identifiers | Content_properties | Rendering_properties | Children |
|---|---|---|---|
| SUBJECT_INFO | <type:form> | | FNAME, |
| | <name:“Subject Info”> | | LNAME, |
| | <tag:FORM_TAG_DM> | | GENDER, DOB |

| Identifiers | Content_properties | Rendering_properties | Children |
|---|---|---|---|
| DEMOGRAPHICS | <type:form> | | NAME, SEX, |
| | <name:“Demographics”> | | BIRTHDATE, |
| | <tag:FORM_TAG_DM> | | ZIP |

As a general case though, complete and all-purpose annotation is unlikely to be encountered in data due to heterogeneous sources of data, legacy data, and variations in annotation definition and requirement. To enable annotation for broader sources of data, the system includes tools and methods to automatically characterize clinical data elements. Characterization may be based on supervised learning or unsupervised learning (without training data).

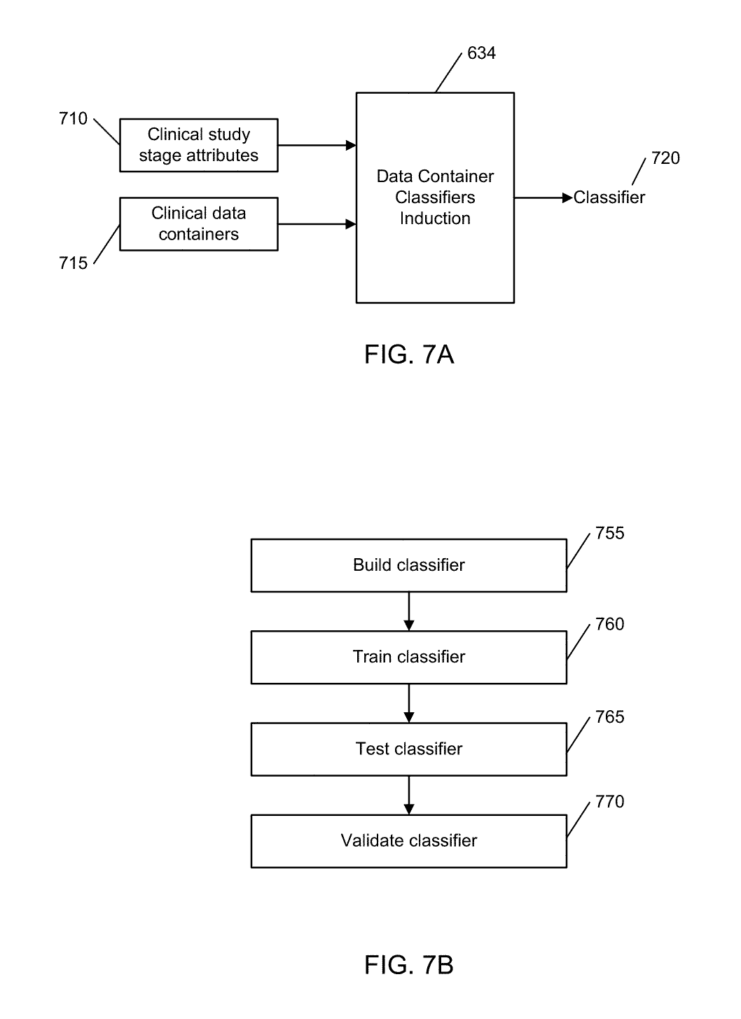

A system (shown in FIG. 7A) and a method (shown in FIG. 7B) are presented to demonstrate how data may be characterized using supervised learning. In FIG. 7A, data container classifiers induction module 634 may use clinical study stage attributes 710 and clinical data container attribute values 715 to generate or induce a classifier 720.

In FIG. 7B, an existing annotation of clinical data containers (and all children clinical data containers) may be used by the system to build a classifier in operation 755 that automatically classifies any clinical data containers for which there is no annotation. For example, based on a set of attribute assignments for a number of studies, e.g., Therapeutic Area (TA), such as dermatology, hematology, oncology, ophthalmology, etc., a classifier may assign one or more of these attributes to any clinical data container of the same type, e.g., study, form, field. The system may compute features based on the clinical data elements for these studies (and all children of the clinical data elements contained), to induce or generate a classifier that may assign one or more of these attributes to any clinical data element of the same type. Accordingly, the system may build a classifier that can be used to produce an annotation for any other clinical data container.

Data container classifiers induction module 634 takes as input a set of clinical data container attribute values and generates data container classifiers (or “calls”), which are the class of the inputs represented by the attributes. The system may train the generated classifier in operation 760, using an annotated training set of data and a selected methodology such as, for example, Linear Regression, Support Vector Machines, and Maximum Entropy. Training typically means that many inputs are used to induce or generate the classifier. Each of the inputs has several attributes and a class assignment. For example, a classifier to determine whether an applicant should be given a line of credit may have several attributes (age, marital status, education, income, zip code) and the label (class) may be whether that candidate is approved. The system may test the generated classifier in operation 765, using an annotated test set of data. Once the classifier is trained/induced, then a similar set of previously unused inputs is used to assess the performance of the classifier in guessing the class on previously unseen inputs from a test dataset. Each of the test set inputs is classified by the classifier, and it is recorded whether the classification module “guessed” the label/class correctly. The system may validate the generated classifier in operation 770, such that given a clinical data element input, one or more attributes with a level of confidence may be returned by the classifier. Since the testing and training can be repeated many times on various combinations of inputs, validation is often used to assess the performance of the classifier on a completely different input set. In some ways, validation is a form of testing, but the use of different data is what makes it different.

An example of this process may be that given a set of clinical study clinical data containers (“training set”) in which each clinical data element is assigned, for example, a Therapeutic Area (e.g., Cardiovascular, Oncology, Endocrine, etc.), the system may build a set of features, which may consist of the term frequencies of all distinct words used across all names of forms in the study. The system may find all clinical data containers where type=“form” and may return an associated name. The system may then extract all unique words in the associated form names and may compute a word (term) frequency in a clinical study clinical data container. For example, all of the text in forms may be split by punctuation and white space leaving behind each word, and then the rate at which each specific word is found is counted. Thus, if “ECG” is prominent in the form names, then this may be used to classify a study as “cardiovascular”; similarly if “chemotherapy” is used frequently in a study, then it is likely that this is an oncology study.

The system may generate an N×M matrix, where N is the number of studies with a given annotation and M is the number of all unique terms found across all forms in all clinical data containers in the training set. The system may use this matrix and the N attribute assignments (or annotations) to induce a classifier using the matrix as a feature vector, which is a vector whose elements are attributes combined or transformed as suitable for the classifier, in this case term frequencies. For any given set of features, various machine learning methods, such as low-memory multinomial logistic regression, also known as maximum entropy, and Stabilized Linear Discriminant Analysis, may be used to induce a classifier.

When the attribute assigned to the clinical data container is not binary (i.e., it can take more than two values), the system may use two approaches to induce classifiers. A single multi-class classifier may be used, where one classifier may be induced and may be given a clinical data container input to the classifier to return one of the full set of attributes. Multiple two-class classifiers may also be used, where for each class value a separate classifier may be induced. Here the two-class classifier determines only if the clinical data container is in one of the multiple classes or not. For example, there may be N classes in which the clinical data containers are labeled C₁, C₂, . . . C_{N}. For each of the N two-class classifiers (the i-th classifier), intermediate labels TRUE and FALSE may be created: TRUE, if the element has the label Cᵢ, or FALSE, if the element does not have the label C. In this case, a clinical data container may be presented to all classifiers, and the set of classifications may determine whether an attribute is assigned or not to the clinical data container. Based on the confidence of the output of each classifier (which is either “N/A” (not able to make a call) or a class “Cᵢ”), the system may decide which labels are assigned to the clinical data container (e.g., using a threshold for the confidence measure—how strong is the call of Cᵢ).

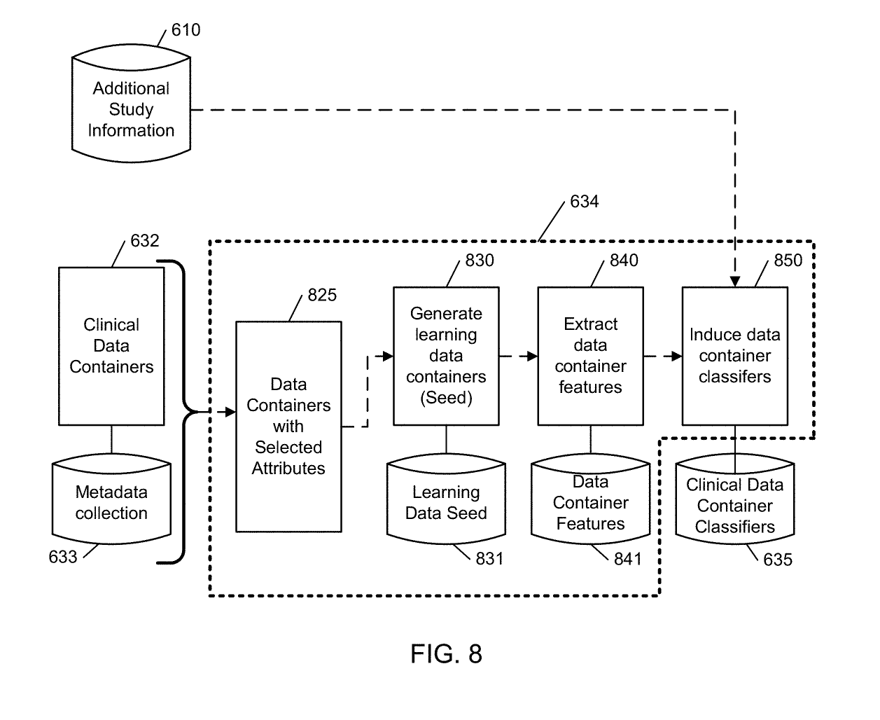

In another embodiment, in the absence of a training set one may be built by using domain knowledge to define the annotations for data containers. FIG. 8 depicts a process in which a set of containers 825 from clinical data containers 632 is selected based on some attribute or property (e.g., all form data containers that have “ECG” in the name are annotated with “EG”, or forms with “Laboratory” contained in the name are annotated with “LB”) and then that data container set is used as a seed for learning data containers. More specifically, data containers 825 having selected attributes are used to generate learning data containers in operation 830, where the learning data seed is stored in database 831. In operation 840, data container features as described with respect to FIG. 7B are extracted and stored in database 841. In operation 850, data container classifiers are induced (as described with respect to FIG. 7B) and stored in database 635. These classifiers may be used in data classification module 624.

The process shown in FIG. 7B can be used with other clinical data containers (not just those derived by Medidata products). For example, the Lilly-ODM Library (see http://www.openhub.net/p/lillyodmlibrary) provides a collection of clinical trial form definitions that can be modeled using this clinical data container paradigm (where each form has a number of child field clinical data containers), but it also contains a label that provides an SD™ domain name attribute for each form. Thus, this collection can be used as training set for an SD™ domain name classification for any form clinical data container.

Besides the operations shown in FIGS. 7B and 8, and the operations described in the above paragraphs, other operations or series of operations are contemplated to monitor clinical study progress. The actual order of operations in the flow diagrams is not intended to be limiting, and the operations may be performed in any practical order.

In general, FIGS. 7A, 7B, and 8 discuss supervised classification. The system may also classify clinical data containers in an unsupervised mode—in the absence of training data with pre-determined classification labels. In this embodiment, the system may classify the clinical data containers first by some measure of closeness (e.g., similarity), which enables grouping of similarly related containers and then possibly assigning classification attributes, either automatically or via manual curation. For example, given the following two field clinical data container definitions, sex and gender, the associated clinical data containers may be classified in the absence of training data.

| Iden- | | | |
|---|---|---|---|
| tifiers | Content_properties | Rendering_properties | Children |
| SEX | <type:field> | <order:2> | |
| | <edit:choice> | | |
| | <label:“Enter subject sex:”> | | |
| | <dictionary:DD_SEX> | | |

| | | | Chil- |
|---|---|---|---|
| Identifiers | Content_properties | Rendering_properties | dren |
| GENDER | <type:field> | <order:3> | |
| | <edit:text> | | |
| | <label:“Enter subject sex:”> | | |
| | <dictionary:SUBJECT_SEX> | | |

Based on the similarities between tags (e.g., label, dictionary, synonymous identifier), the system may use an algorithm as discussed below to group fields such as these, sex and gender, together and leave other fields to be grouped elsewhere.

One algorithm may be based on a distance function that may be a composite measure of similarity between various clinical data container attributes. For example, if each clinical data container has N properties, the following may define the distance function DIST between any two clinical data containers:

DIST(<attr₁, attr₂, . . . attr_{N}>_{cde1}, <attr₁, attr₂, . . . attr_{N}>_{cde2}, <sm₁, sm₂, . . . sm_{N}>, <w₁, w₂, . . . , w_{N}>)
where attr=clinical data container attributes; sm=similarity measures (e.g., string distance, equivalence of values each returning a value between 0.0 and 1.0); and w=weights to ensure that w₁*sm₁+w₂*sm₂+ . . . +w_{N}*sm_{N}=1.0. For this algorithm example, since distance is a decimal number between 0 and 1, two containers having a distance of 0.04 would be considered nearly identical, whereas two containers having a distance of 0.954 would not be considered at all similar. In the case in which two or more fields are grouped, a manual step may assign the FIELD_TAG_DM_SEX tag to these fields, or an automated tag may be generated based on most prominent attributes, for example SEX_GENDER or “Enter subject sex” for the fields above.

Referring now to FIG. 6C, the output of study stage annotation module 626 (arrow 636) is input to aggregation module 650 and to generate models module 642. Aggregation module 650 may extract classified and annotated data required to compute output for models 645. Generate models module 642 generates models 645 based on the custom study stage data from multiple compatible studies. These models can be used to compute one or more states, which are further used to predict or optimize some property of the custom study stage. The system may evaluate precisely defined subsets of clinical data elements, including data from subjects, sites, and across multiple studies. Based on the custom study stage data from other relevant studies, the system may generate models that will predict or optimize some property of the custom study stage. Specifically, the system may extract relevant data elements from custom study stages across multiple compatible studies. The extracted relevant custom study stage data may be normalized across time and state and may be translated into custom study stage features. In combination with existing outcomes, the system may generate a model for a target property, such as predicted time to complete a stage (“completion prediction”). The system may also plug custom study stage data into an existing model and may present the model output to a user.

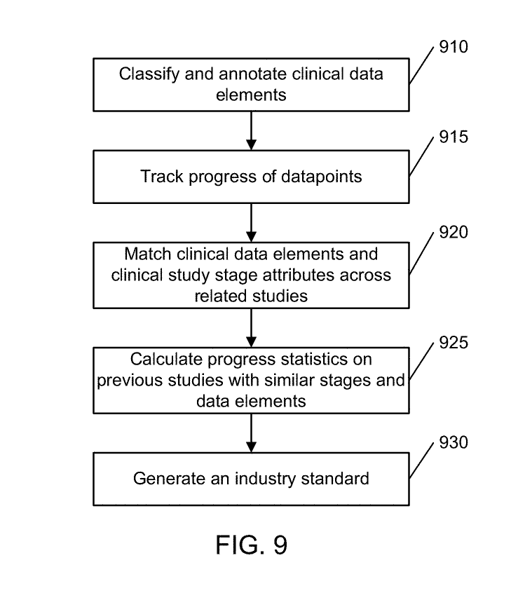

Another embodiment shows the progression of a study per custom study stage, which may allow the generation of a progress status model relative to a baseline or an industry standard computed from historical data of a group of clinical studies, as shown in FIG. 9. The system may classify and annotate clinical data elements in operation 910 and then use the classified and annotated clinical data elements to track the progress of datapoints in operation 915, as is discussed below in the context of a single clinical study. The system may evaluate the rate and other properties of aggregation of data in datapoints or change of status of data elements (datapoints, forms, folders) within a custom study stage. This system allows multiple studies to be evaluated using the same study stages and annotation. These properties are another embodiment of a progress status model. By matching and performing a comparative analysis of clinical data elements and clinical study stages across related studies in operation 920, the system may calculate progress statistics for these previous related studies which include similar stages and data elements in operation 925. The system may thus also evaluate the relative progress of a study per custom study stage. By measuring the rate and other properties of aggregation of data in datapoints or change of status of data elements (datapoints, forms, folders) within well-defined parts of the study, the system may measure the progress and changes in progress within stages of the study for each study site. By enabling precise comparison of the performance for each study site, the system may compare any site or group of sites to all remaining sites in the study.

These progress statistics may be used by the system to generate an industry standard in operation 930 by comparing data across all subjects and sites in a study, as well as equivalent data from previous studies (and sites in previous studies). By classifying and annotating study data elements, tracking progress of datapoints, and matching data elements and stages across related studies, the system may generate this industry standard by calculating progress statistics on previous studies with similar stages and data elements, which may be used to score sites or an entire study relative to a standard performance.

Besides the operations shown in FIG. 9, other operations or series of operations are contemplated to monitor clinical study progress. The actual orders of operations in the flow diagrams are not intended to be limiting, and the operations may be performed in any practical order.

In another embodiment, the system may use these progress statistics to generate metrics that track enrollment and screening failures. For example, using system-generated characterized study design elements, subjects may be characterized using input such as data entered in forms of given type (e.g., demographics, vitals, inclusion/exclusion in screening); data entered in all forms of a stage (e.g., screening) for patients to be considered promoted to subsequent stages; and lengths of time between time points (e.g., data element creation, first data input, last data input) for duration of a stage. The system may evaluate such measurements to generate metrics to provide certain insights and then modify the study.

For example, the data may show how consistent a site is with respect to data entry across subjects. Some sites may be entering all screening data for all patients on time (e.g., within 1 day of visit), while other sites may be adding a lag of one week or more. In another example, the data may show that the rate of subjects entering screening is substantially lower in one site compared to another, or the rate of subjects entering screening compared to subjects entering randomization is lower in one site than another. A corrective action could include revisiting targets for these two sites and increasing the target for the site that has been steadily recruiting patients.

Additionally, based on statistical models of subject enrollment, the system may be used to estimate time-to-target enrollment of sites and model changes in target enrollment across sites in the study. Typically, enrollment and recruitment model parameters rely on or can be derived from data similar to the metrics previously described (e.g., rate of new subjects, fraction of subjects completing stage, length of stage per subject). Using such data from prior studies can be used to derive parameters for existing models to provide estimates for new future recruitments at each site. Given these estimates, one may compute at which point in the future the target enrollment will be reached.

Referring back to FIG. 6C, models 645 may be used to integrate aggregated data in block 655, which includes, as examples, several types of aggregated data processing: progress curves, metric computation, and predictive/optimization model calculation. Progress curves 660, which were described in U.S. patent application Ser. No. 14/492,597 and above in the discussion accompanying FIGS. 4A-4D, are one of the methods used to transform study data. This aggregation based on clinical data elements monitors progress per site and study stages or for the study overall, and the annotation of clinical data elements may be combined with data statuses. In the example shown in FIG. 2A, the system aggregates data for each patient under the study stage.

Metrics module 670 calculates metrics based on the progress curves. As described above, metrics module 670 may describe the progression of a study by custom study stage and may track enrollment and screening failures. This module may provide recommendations and/or status of the clinical study, and may provide alerts if a clinical study is not proceeding according to plan.

With defined custom study stages, progress information can be determined and unique characterizations can be derived in the form of study states based on one or more progress status models. Such states may be in the form of metrics or predictors. One set of metrics may be similar to progress curves generated in the previous application, U.S. patent application Ser. No. 14/492,597, and may be used to view and quantify cumulative properties in the creation and processing of data. Specifically, the system may extract relevant data from a custom study stage, normalize associated clinical study stage data across time and states, compute subject/site/study metrics, and present data to the user. This process may be used to track and measure the progress of data entered/modified/verified in real time or historically using classified study data elements and to perform a comparative analysis of data entered or processed in the custom study stage.

With respect to prediction/optimization model 680, in one embodiment the system may build predictors that estimate the completion of stages within a study and the study overall based on the duration of study stages and data element processes. These predictors may estimate the time to complete a stage in a study, the time to complete a status change (e.g., verification, locking), or the expected time to complete the overall study, even before enrollment is completed. More specifically, the system may generate a model in block 645 to which is inputted the target number of subjects for the stage (or the study), the sites used, and the type of study (e.g., which therapeutic area and phase) and which can output the estimated time (e.g., number of weeks) to completion. Generating such a model involves providing data from past studies for the specific stage, for example, and the measured completion to derive a model (e.g., linear regression). Thus the system is able to provide precise and normalized data to better derive such models.

Visualization module 690 may present model states and progress curves on a user's computer, allowing the user 695 to manipulate how the data may appear. User 695 may be able to view the model states on a laptop or desktop computer or on a smartphone or tablet. Some examples of visualization are shown in FIGS. 4A-4D and FIGS. 5A-5D.

In sum, a system has been developed that is able to track the progress of a clinical study by defining custom study stages and tracking those stages. In defining the stages, the system may use pre-annotated clinical study data elements or classify clinical study data elements based on annotations from a number of clinical studies. The system may directly use such annotation to delineate a custom study stage, or it may be used in combination with the described study element classification methods to provide finer granularity of data elements within such a custom study stage, enhanced by classification tools discussed above.

Aspects of the present invention may be embodied in the form of a system, a computer program product, or a method. Similarly, aspects of the present invention may be embodied as hardware, software, or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof. A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer programs that may be associated with applications of the system for monitoring the progress of a clinical study (called “computer control logic”) may be stored in the main memory or in secondary memory. Such computer programs may also be received via a communications interface. Such computer programs, when executed, may enable the computer system to perform the features as discussed herein. In particular, the computer programs, when executed, may enable the processor to perform the described techniques. Accordingly, such computer programs may represent controllers of the computer system.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

In one embodiment, the computer-based methods may be accessed or implemented over the World Wide Web by providing access via a Web Page to the methods described herein. Accordingly, the Web Page may be identified by a URL. The URL may denote both a server and a particular file or page on the server. In this embodiment, it is envisioned that a client computer system may interact with a browser to select a particular URL, which in turn may cause the browser to send a request for that URL or page to the server identified in the URL. Typically, the server may respond to the request by retrieving the requested page and transmitting the data for that page back to the requesting client computer system (the client/server interaction may be typically performed in accordance with HTTP). The selected page may then be displayed to the user on the client's display screen. The client may then cause the server containing a computer program to launch an application, for example, to perform an analysis according to the described techniques. In another implementation, the server may download an application to be run on the client to perform an analysis according to the described techniques.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An improved system for tracking the progress of a clinical study, comprising:
a classifier generator including a processor for automatically generating clinical data element classifiers by evaluating clinical data containers and clinical study stage attributes across clinical studies;
a classifier application subsystem including a processor that applies the clinical data element classifiers to classify clinical data elements into pre-determined categories;
a study stage annotation subsystem including a processor that uses the clinical data element classifiers and the classified clinical data elements to determine clinical study stages;
a progress status models generator for generating at least one progress status model based on the clinical study stages;
an aggregation module including a processor for selecting and aggregating the classified clinical data elements and clinical study stages; and
a progress status evaluation subsystem for computing the state of at least one progress status model,
wherein the progress status evaluation subsystem generates at least one progress status of the clinical study by using the clinical data element classifiers and clinical data to compare contextualized study properties of one or more associated clinical study stages.

2. The improved system of claim 1, wherein the clinical data element classifiers are induced using metadata from clinical data containers using a data container classifiers induction module.

3. The improved system of claim 1, wherein the clinical data elements are pre-annotated.

4. The improved system of claim 1, wherein the progress status model is generated from classified and annotated clinical data elements.

5. The improved system of claim 1, wherein the progress status model is pre-specified.

6. The improved system of claim 1, wherein the progress status model is used to compare contextualized study properties of one or more associated clinical study stages relative to the clinical study.

7. The improved system of claim 1, wherein the progress status model is used to compare contextualized study properties of one or more associated clinical study stages relative to a collection of related clinical studies.

8. The improved system of claim 1, wherein the system computes the state of the progress status model in the form of metrics.

9. The improved system of claim 1, wherein the system computes the state of the progress status model in the form of a prediction.

10. The improved system of claim 1, wherein the system computes the state of the progress status model at the study level.

11. The improved system of claim 1, wherein the system computes the state of the progress status model at least at the site level.

12. The improved system of claim 1, wherein the system computes the state of the progress status model at least at the subject level.

13. An improved method for tracking the progress of a clinical study, comprising:
automatically generating clinical data element classifiers by evaluating clinical data containers and clinical study stage attributes across clinical studies;
classifying clinical data elements into pre-determined categories based on the clinical data element classifiers;
determining clinical study stages based on the clinical data element classifiers and the classified clinical data elements;
generating at least one progress status model based on the clinical study stages;
selecting and aggregating the classified clinical data elements and clinical study stages; and
computing the state of the at least one progress status model,
wherein the computing the state of the at least one progress status model comprises generating at least one progress status of the clinical study by using the clinical data element classifiers and clinical data to compare contextualized study properties of one or more associated clinical study stages.

14. The improved method of claim 13, wherein the clinical data element classifiers are induced using metadata from clinical data containers using a data container classifiers induction module.

15. The improved method of claim 13, wherein the clinical data elements are pre-annotated.

16. The improved method of claim 13, wherein the progress status model is generated from classified and annotated clinical data elements.

17. The improved method of claim 13, wherein the progress status model is pre-specified.

18. The improved method of claim 13, wherein the progress status model is used to compare contextualized study properties of one or more associated clinical study stages relative to the clinical study.

19. The improved method of claim 13, wherein the progress status model is used to compare contextualized study properties of one or more associated clinical study stages relative to a collection of related clinical studies.

20. The improved method of claim 13, wherein the state of the progress status model is computed in the form of metrics.

21. The improved method of claim 13, wherein the state of the progress status model is computed in the form of a prediction.

22. The improved method of claim 13, wherein the state of the progress status model is computed at the study level.

23. The improved method of claim 13, wherein the state of the progress status model is computed at least at the site level.

24. The improved method of claim 13, wherein the state of the progress status model is computed at least at the subject level.
